(19) United States
(12) Patent Application Publication
(10) Pub. No.: US 2012/0113119 A1
(43) Pub. Date: May 10, 2012

(54) SUPER RESOLUTION INFRARED IMAGING SYSTEM

(75) Inventor: Mark Alan Massie, Santa Ynez, CA (US)

(73) Assignee: NOVA RESEARCH, INC., Solvang, CA (US)

(21) Appl. No.: 13/289,844

(22) Filed: Nov. 4, 2011

Related U.S. Application Data
(60) Provisional application No. 61/410,652, filed on Nov. 5, 2010.

(51) Int. Cl. G06T 5/00

(52) U.S. Cl. 345/428

(57) ABSTRACT

A method for super resolution enhancement of infrared imaging data employing an image array having simultaneous, high speed, randomly addressable windows of pixels for small regions of interest (ROI) within a large imaging sensor field of view. Data is retrieved from the ROI window pixels at an increased data rate and the array is dithered to produce sub-pixel motion consistent with the increased data rate. A selected super resolution (SR) algorithm is then applied to the data retrieved from the ROT window pixels at the increased data rate. The reduced data set substantially relieves the computational load on the processor compared with the requirement of performing SR processing on the entire frame of image data. The output from the SR algorithm is either used to replace the LR frame data in the image or is displayed as a separate image to the user.

### REFERENCE TO RELATED APPLICATIONS

This application claims the priority of U.S. Provisional Application Ser. No. 61410652 filed on Nov. 5, 2010 entitled SUPER RESOLUTION INFRARED IMAGING SYSTEM BACKGROUND INFORMATION the disclosure of which is incorporated herein by reference as though fully set forth.

### BACKGROUND INFORMATION

1. Field

Embodiments of the disclosure relate generally to the field of read-out integrated circuits (ROIC) for infrared sensors and more particularly to embodiments for an infrared imaging camera system that provides super resolution image data using a multiple windowing focal plane array readout integrated circuit (ROIC) that permits a selected number of small, two-dimensional image portions to be read off of the focal plane array (FPA) at high rates with sub-pixel motion of imagery for dithering of the data in a super resolution processor.

2. Background

Infrared detection and imaging systems are being employed to sense temperature differences to create scenes displaying various objects. Current imagers provide exceptional acuity for scene reproduction. To maintain desired frame rates lower resolution in output from the imaging array is often required. However, certain features of interest in an image may require super resolution for adequate display. Current resolution enhancement systems require operation on the pixels of the entire array significantly reducing frame rate capability for display.

It is therefore desirable to provide arrays with ROICs which allow super resolution processing on only selected portions of the array to maintain high frame rates for the overall image.

### SUMMARY

Exemplary embodiments provide a method for super resolution enhancement of infrared imaging data employing an image array having simultaneous, high speed, randomly addressable windows of pixels for small regions of interest (ROI) within a large imaging sensor field of view. Data is retrieved from the ROI window pixels at an increased data rate and the array is dithered to produce sub-pixel motion consistent with the increased data rate. A selected super resolution (SR) algorithm is then applied to the data retrieved from the ROI window pixels at the increased data rate.

In exemplary embodiments, the output from the super resolution (SR) algorithm is either used to replace the low resolution (LR) frame data in the image or is displayed as a separate image to the user. Dithering may be accomplished with mechanical or optical dithering and processing of the SR algorithm may be accomplished in a Field Programmable Gate Array (FPGA), a computer, or a computational neural network (CNN) computer. In many cases, the natural motion of the camera produces enough dithering to satisfy the requirements of this method.

The features, functions, and advantages that have been discussed can be achieved independently in various embodiments of the present invention or may be combined in yet other embodiments further details of which can be seen with reference to the following description and drawings

### BRIEF DESCRIPTION OF THE DRAWINGS

FIG. 1 is an image of data from an infrared imaging array with a windowed super resolution region of interest;

FIG. 2 is a zoomed image of the windowed super resolution region of interest of FIG. 1;

FIG. 3 is a schematic representation of an exemplary focal plane array with windowing capability;

FIG. 4A is a schematic representation of the array of FIG. 3 with exemplary readout and supporting processing capability employing a CNN processor;

FIG. 4B is a schematic representation of the array of FIG. 3 is an alternative processing capability employing a Field Programmable Gate Array;

FIG. 5 is a schematic representation of tiled pixels in the array of FIG. 3;

FIGS. 6A-6C are images of low resolution data, super resolution data enhanced by sequential operation on dithered low resolution data using a first super resolution algorithm and a second super resolution algorithm;

FIGS. 7A-7C are zoomed images of selected portions of the images of FIGS. 6A-6C respectively; and,

FIG. 8 is a graph of quantitative comparison between modulation efficiencies for the low resolution input data and the super resolution output data shown in the images of FIGS. 7A-7C.

### DETAILED DESCRIPTION

The embodiments described herein provide a “tiled” ROIC architecture that permits data from user-selected small, two-dimensional image portions in windowed pixels to be read off of the focal plane array (FPA) at high rates while data from the entire array is processed at a frame rate for lower resolution (LR) data. The image data from the selected windowed pixels is then provided to a near-FPA field programmable gate array (FPGA) or other processor for evaluation using a super resolution (SR) processing algorithm. Active mechanical or optical dithering of the infrared imaging array for the purpose of producing sub-pixel motion is exploited in the processing algorithm to create SR imaging of the selected windowed portions of the array.

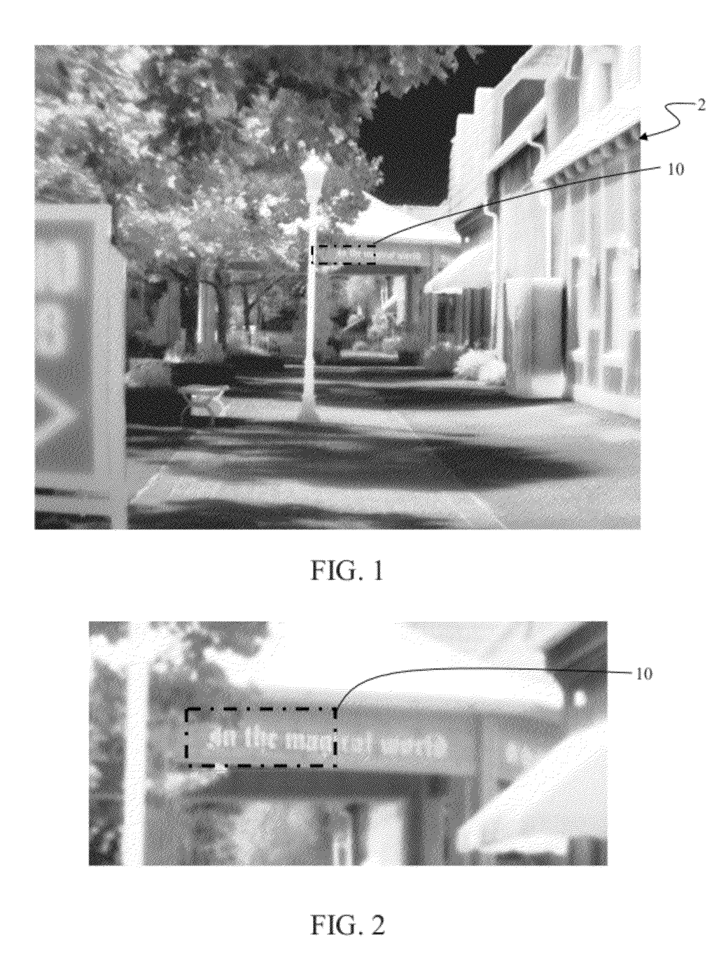

FIG. 1 shows an image 2 produced by a 640×512 pixel midwave infrared (MWIR) camera having an FPA and ROIC architecture according to the present embodiments. The region defined by box 10 was selected as a region of interest (ROI) for SR processing, as will be described in greater detail subsequently. FIG. 2 is a zoomed-in view showing the windowed region (box 10) in greater detail and demonstrating the SR effect compared to the normal LR data presented on the remainder of the display.

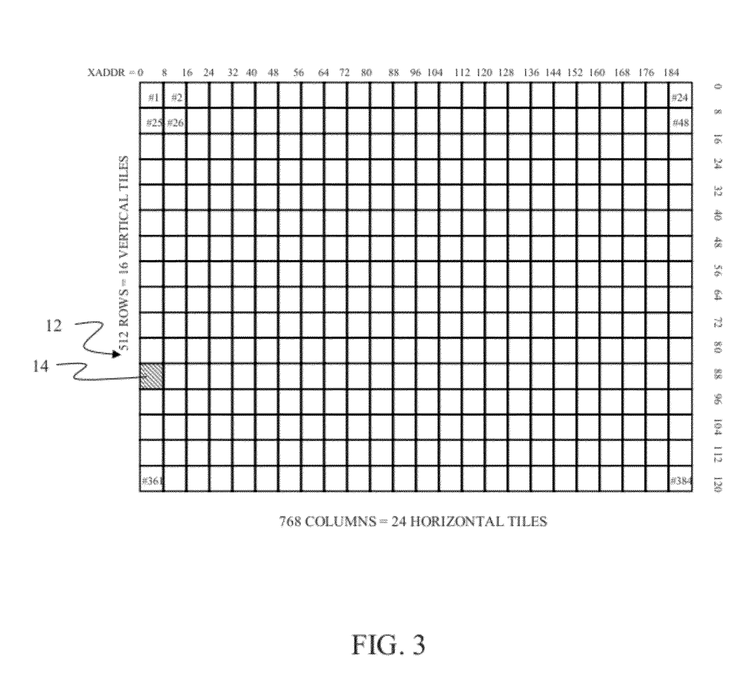

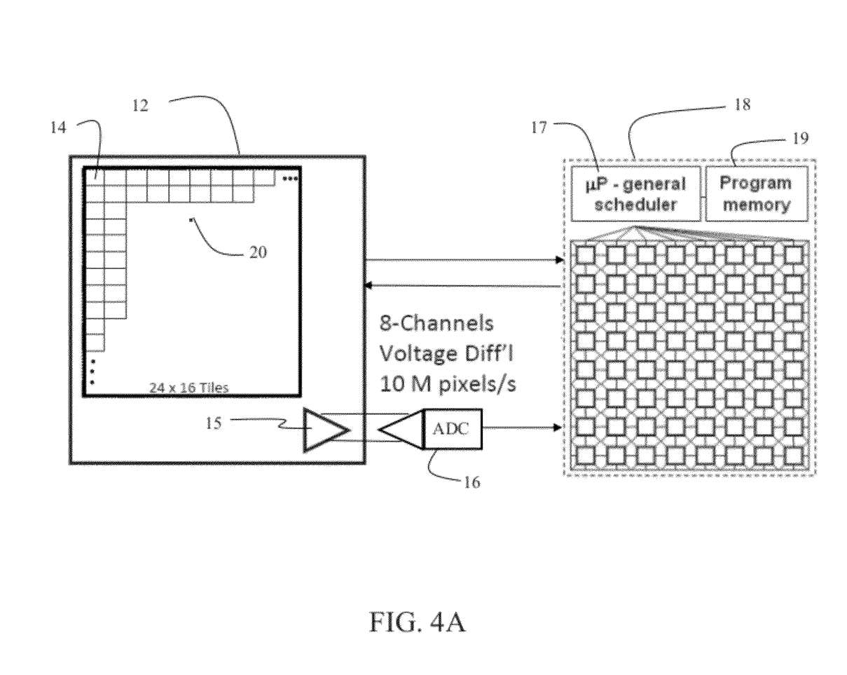

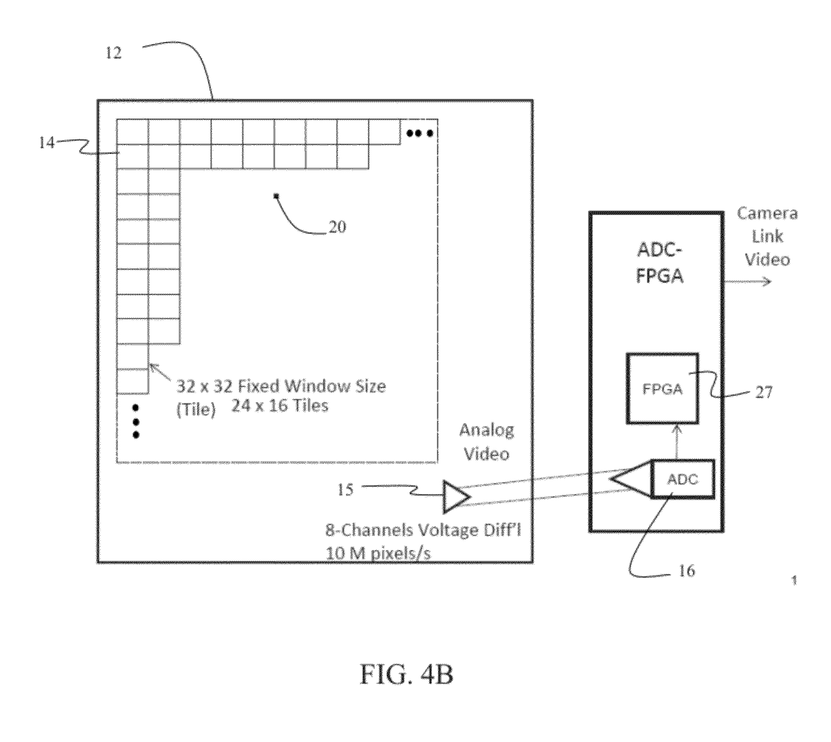

An exemplary imagine array structure which provides for the windowing capability to access particular ROIs is shown in FIG. 3. While shown as exemplary of an FPA and readout architecture applicable to the method of the present embodiment, alternative selectively addressable arrays could be employed, The ROIC architecture for the array 12 is composed of multiple 32×32 pixel tiles 14 that may be addressed in random fashion. 32×32 pixel tiles are used to compose the entire 768×512 array; eight parallel 14-bit analog-to-digital converters (ADCs) 16, shown in FIGS. 4A and 4B, are attached to individual tiles so there are never any “lost” digitizing cycles. A processor 18 such as a “cellular neural network” (CNN) processor shown in FIG. 4A may select any or all tiles from the ROIC at the current frame rate based on image analytic functions implemented in the processor by a general scheduler 17. The processor, which in an example embodiment is a EUTECUS CNN Processor Array available from Eutecus, Inc. 1936 University Ave., Suite 360, Berkeley, Calif. 94704, can provide computing for target detection in clutter, decoy discrimination, multi-target tracking and high-level functions based on that selection ability. A program memory 19 is associated with the processor.

The native pixels 20 creating the 32×32 pixel tiles for an example embodiment are 27×27 um pixels in a 763×512 array providing 393,000 pixels.

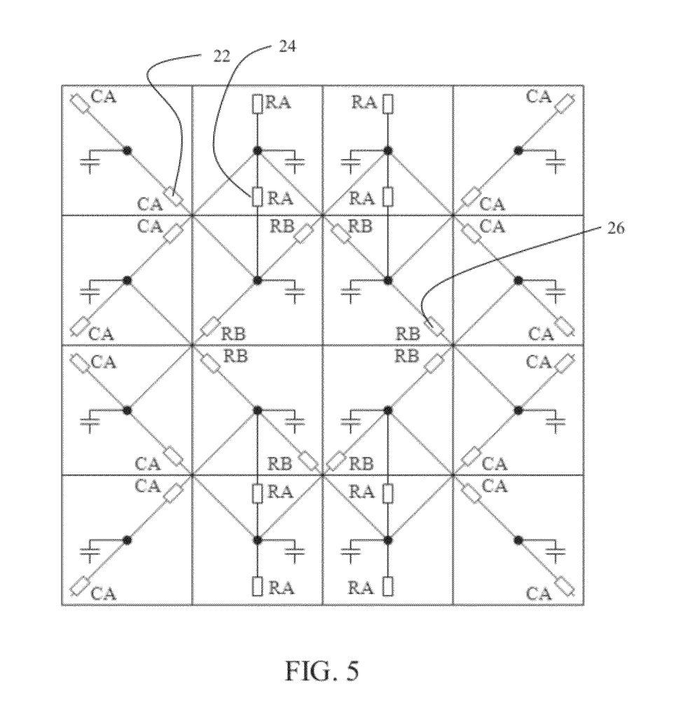

In addition to addressability of individual tiles by the ADCs 16, 1×1, 2×2 and 4×4 “in tile” spatial binning is supported by the ROIC resulting in operating modes that either (a) produce extremely high frame rates or (b) produce very low output data bandwidth for the device. FIG. 5 shows the general architecture for a 4×4 group of pixels in the array that are interconnected with symmetrical switches that allow for charge sharing in 1×1 (i.e., complete isolation), 2×2 and 4×4 charge sharing modes. As shown, the 2×2 charge sharing mode is accomplished by closing the “CA” and “RA” switches 22, 24. Closing all the “CA” 22, “RA” 24 and “RB” 26 switches produces a 4×4 pixel charge sharing condition.

Data from the pixels in the selected window for the ROI is read off the FPA at high rates relative to the overall frame rate for FPA as a whole which produces the normal low resolution (LR) scene data. In the example embodiment, the 32×32 fixed window size is read at 73,000 frames/second with the ADCs 16 receiving input from 8 channels of voltage differential amplifiers 15 for analog video at 10 M pixels/sec.

Active mechanical or optical dithering is imposed on the FPA to produce sub-pixel motion consistent with the high rate readout for the windowed pixels. The data received is then operated on using a super resolution algorithm such as the method of Projection onto Convex Sets (POCS), the Method of Irani and Peleg or Method of Total Variation Inpainting, as examples, which may be implemented in the processor 18 or a separate digital computing device such as a Field Programmable Gate Array (FPGA) 27. As shown in FIG. 4B, the FPGA in certain embodiments may be incorporated in conjunction with the ADC circuitry. Multiple sequential calculations on the dithered output provide an enhancement of the apparent number of pixels increasing the resolution for a SR output on the ROI.

The SR enhancement for the images shown in FIGS. 1 and 2 used the gentle image motion induced by the vibration of the camera's electric cryocooler to spatially modulate the image data. While not a perfect spatial dither condition, nonetheless qualitative resolution improvement is seen in the figures.

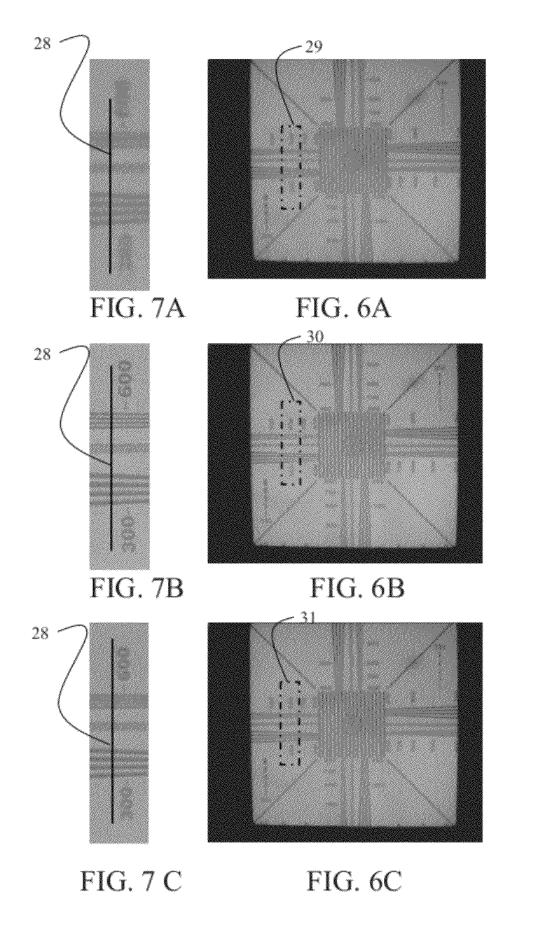

To demonstrate the SR algorithm operation, FIGS. 6A, 6b and 6C show exemplary images from MWIR image data with a 320×256 pixel @30 um pitch camera. FIG. 6A shows normal LR data produced by the camera. FIG. 6B shows the resulting 640×512 pixel equivalent super resolution product obtained by operating on ten (10) sequential frames of the low resolution dithered input data with the fully-implemented POCS technique implemented in Matlab. CC shows the respective result obtained by operating on ten (10) sequential frames of the low resolution dithered input data with a “Fast”-POCS technique implemented in Matlab. Notice the Fast-POCS is not quite as sharp and contains less granular noise when compared to the original POCS result (FIG. 6B).

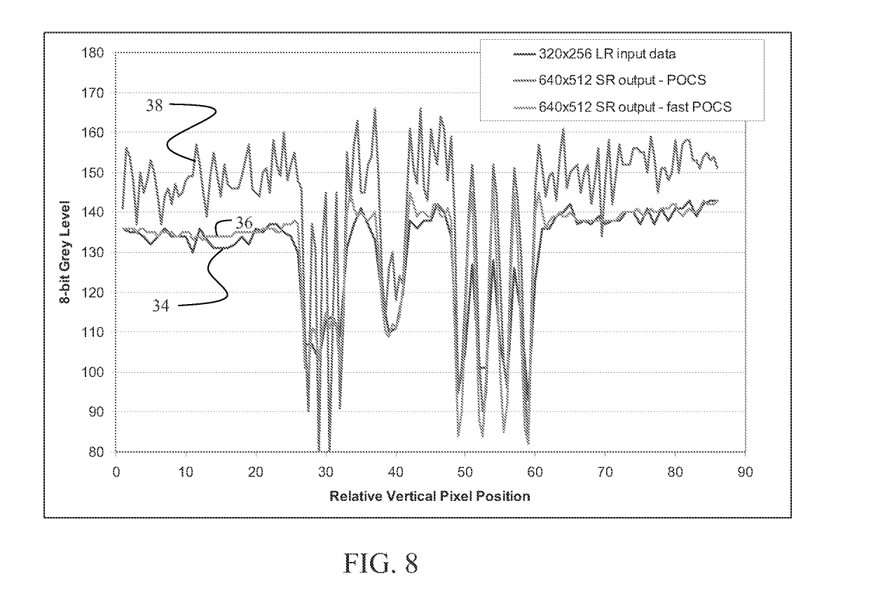

FIG. 8 quantitatively compares the three images of FIGS. 6A-6B by looking at the 8-bit grey levels through a single vertical slice of each image, shown as line 28 in FIGS. 7A, 7B and 7C which are enlargements of the same portion of FIGS. 6A-6C denoted by boxes 29, 30 and 31 respectively. The graph provides a comparison of 8-bit grey level to relative vertical pixel position taken along line 28 for each image. Comparing to the LR input data, trace 34, the Fast-POCS, trace 36, is not as effective as the original POCS, trace 38, at restoring the high frequency data shown around the vertical pixel position 30. However, it does show effectiveness at slightly lower frequencies, shown between vertical pixel positions 50 and 60.

The POCS algorithms rely on an iterative procedure for continually refining the SR result by successively propagating high frequency corrections onto the SR image. For the exemplary images of FIGS. 6A-6C, the corrections are made pixel by pixel, for all LR images. The difference between the original and the fast-POCS methods resides in minimizing repetition by attempting to perform some of the operations on the entire image, rather than one pixel at a time. This philosophy lends itself well to implementation on a readout integrated circuit (ROIC) as those devices can perform massively parallel operations on all pixels.

The windowing capability as described with respect to FIGS. 1-5 above allows rapid processing of ROI data within the normal frame rates of the LR processing for the entire array thereby avoiding the requirement for processing data from the entire array using the SR algorithm. The SR processed data is then inserted into the frame output for the pixels in the windows of the ROI replacing the LR data normally obtained in the frame for those pixels thereby providing the enhanced image portions as represented by box 10 in FIGS. 1 and 2.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A method for super resolution enhancement of infrared imaging data comprising:
providing an imaging array having simultaneous, high speed, randomly addressable windows of pixels for small regions of interest (ROI) within a large imaging sensor field of view;
retrieving data from the ROI window pixels at an increased data rate relative to image frame rate;
dithering the array to produce sub-pixel motion consistent with the increased data rate; and,
applying a selected super resolution (SR) algorithm to the data retrieved from the ROI window pixels at the increased data rate.

2. The method super resolution enhancement of infrared imaging data as defined in claim 1 farther comprising:
replacing LR frame data for the window pixels with an output from the SR algorithm for image display.

3. The method super resolution enhancement of infrared imaging data as defined in claim 1 wherein the dithering is active mechanical dithering of the array.

4. The method super resolution enhancement of infrared imaging data as defined in claim 1 wherein the dithering is optical dithering.

5. The method super resolution enhancement of infrared imaging data as defined in claim 1 wherein the SR algorithm is selected from the set of Method of Projection onto Convex Sets (POCS), Method of Irani and Peleg and, Method of Total Variation inpainting.

6. The method super resolution enhancement of infrared imaging data as defined in claim 1 wherein the SR algorithm is applied in a digital computing device.

7. The method super resolution enhancement of infrared imaging data as defined in claim 6 wherein the digital computing device is selected from the set of a Field Programmable Gate Array (FPGA), a computer, and a computational neural network (CNN) computer.
